(19) United States
(12) Patent Application Publication
(10) Pub. No.: US 2015/0106224 A1
(43) Pub. Date: Apr. 16, 2015

(54) DETERMINING PICKING COSTS FOR A SET OF CANDIDATE PRODUCTS FOR A PRODUCT ORDER

(71) Applicant: INTERNATIONAL BUSINESS MACHINES CORPORATION, Armonk, NY (US)

(72) Inventors: Mark B. Stevens, Austin, TX (US); John D. Wilson, Houston, TX (US)

(73) Assignee: INTERNATIONAL BUSINESS MACHINES CORPORATION, Armonk, NY (US)

(21) Appl. No.: 14/055,679

(22) Filed: Oct. 16, 2013

(51) Int. Cl. G06Q 30/06

(52) U.S. Cl. CPC G06Q 30/0631
USPC 705/26.7

(57) ABSTRACT

A method, system or computer usable program product for offering a set of candidate products that have a lower picking cost including detecting a product selected for purchase by a user; identifying a list of proximate products to the product selected for purchase; utilizing a processor for ranking the proximate products considering incremental picking costs and applicability of the proximate products to the product selected for purchase to determine picking scores for a subset of the proximate products in the list of proximate products; and presenting to the user the set of candidate products selected from the subset of proximate products based on the picking scores.

### BACKGROUND

1. Technical Field

The present invention relates generally to determining picking costs, and in particular, to a computer implemented method for determining picking costs for a set of candidate products for a product order.

2. Description of Related Art

A variety of costs are incurred in shipping products to customers. Although many of those costs may be passed directly to the customer as extra charges, some companies allow the customer to choose free shipping so long as the customer is willing to accept slow (i.e., cheaper) delivery of those products such as a week or more. The customer may request more rapid shipping, but at an extra cost. These shipping costs can include the cost of packaging the products for shipping and the actual shipping of those products. Generally packaging may be an internal process, although it may be outsourced to contractors. The type of packaging for a given product can depend on the delivery speed requested by the customer and the shipper chosen by the seller. Shipping is typically outsourced to a variety of carriers that specialize in that field. Each shipper may have specific packaging requirements and prices based on that packaging. For example, one shipper may not be as weight sensitive so long as the product being shipped is within a small box provided by the shipper. Another shipper may be more weight sensitive, but allow larger boxes for shipping. As a result, different shippers may be utilized for shipping products depending on the size and weight of those products.

Given the above described costs, product sellers have works on optimizing product orders based on these packaging and shipping costs. For example, warehouses may be strategically located near points of sale or near shipping points such as airports or train terminals. In addition, various techniques for selling products may be primarily oriented to taking into account packaging and shipping costs when determining which products to offer for sale or as an upsell.

### SUMMARY

The illustrative embodiments provide a method, system, and computer usable program product for offering a set of candidate products that have a lower picking cost including detecting a product selected for purchase by a user; identifying a list of proximate products to the product selected for purchase; utilizing a processor for ranking the proximate products considering incremental picking costs and applicability of the proximate products to the product selected for purchase to determine picking scores for a subset of the proximate products in the list of proximate products; and presenting to the user the set of candidate products selected from the subset of proximate products based on the picking scores.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a customer ordering system in which various embodiments may be implemented;

FIGS. 4A and 4B are block diagrams of an example warehouse and a rack utilized for storing products for picking in which various embodiments may be implemented;

FIG. 5 is a flow diagram of identifying and offering products for upselling in accordance with a first embodiment;

FIG. 6 is a flow diagram of identifying and offering products for upselling in accordance with a second embodiment;

FIGS. 7A through 7E are block diagrams of record entries into the various databases in which various embodiments may be implemented; and

FIG. 8 is a block diagram of a user interface for upselling in which various embodiments may be implemented.

### DETAILED DESCRIPTION

Processes and devices may be implemented and utilized for determining picking costs. These processes and apparatuses may be implemented and utilized as will be explained with reference to the various embodiments below.

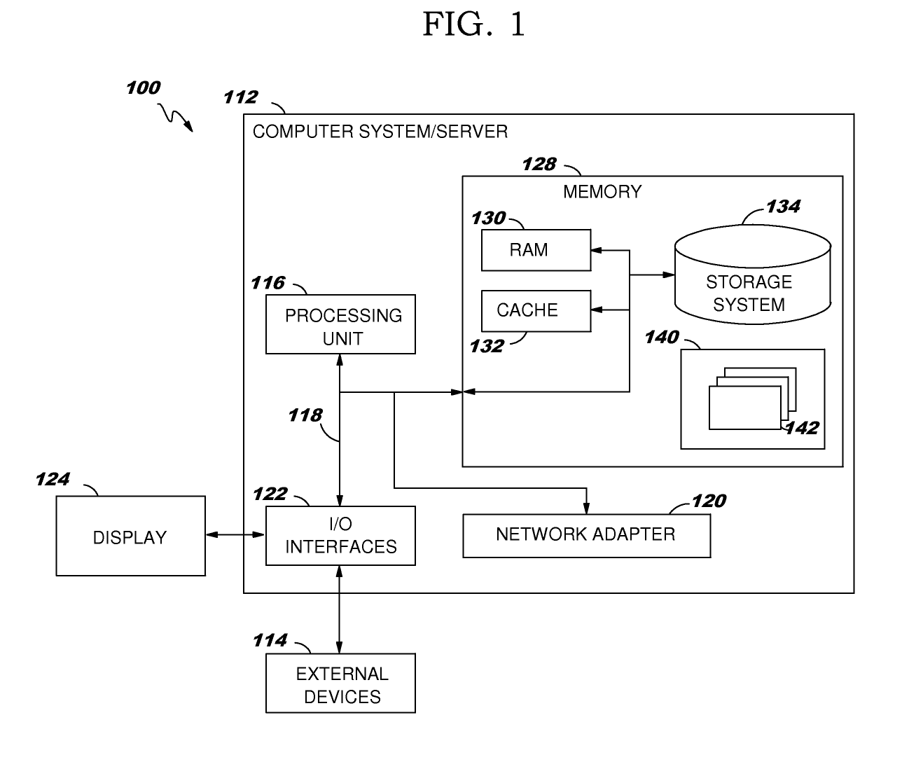

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as determining picking costs.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system readable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for determining picking costs.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

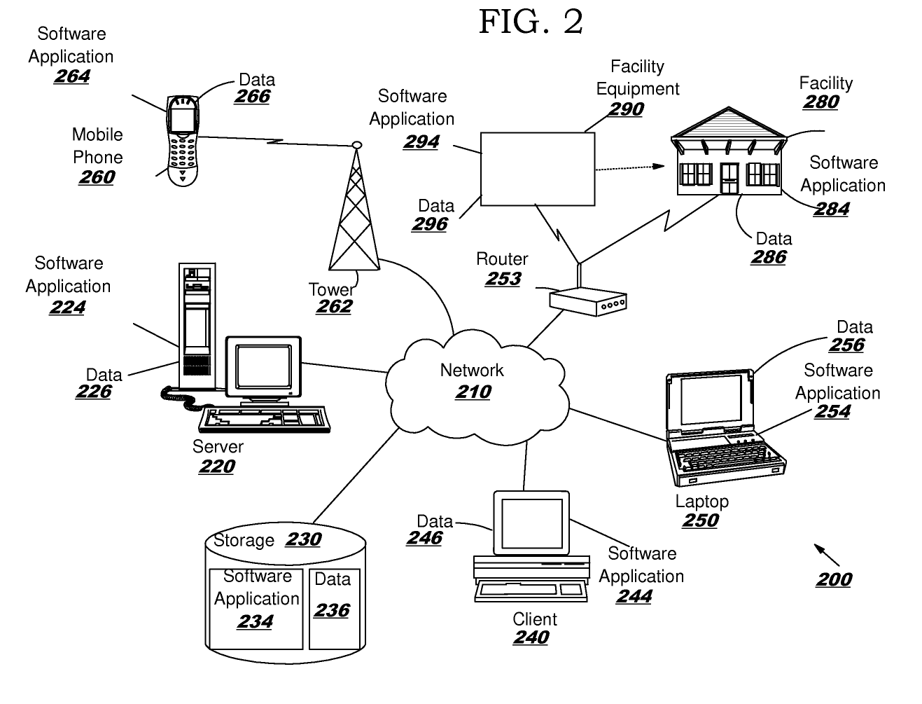

FIG. 2 is a block diagram of an illustrative network of data processing systems in which various embodiments of the present disclosure may be implemented. Data processing environment 200 is a network of data processing systems such as described above with reference to FIG. 1. Software applications such as for determining picking costs may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250, facility 280 (such as a home or business) and facility equipment 290 are coupled to network 210 including wirelessly such as through a network router 253. A mobile phone 260 may be coupled to network 210 through a mobile phone tower 262. Data processing systems, such as server 220, client 240, laptop 250, mobile phone 260, facility 280 and facility equipment 290 contain data and have software applications including software tools executing thereon. Other types of data processing systems such as personal digital assistants (PDAs), smartphones, tablets and netbooks may be coupled to network 210.

Server 220 may include software application 224 and data 226 for determining picking costs or other software applications and data in accordance with embodiments described herein. Storage 230 may contain software application 234 and a content source such as data 236 for determining picking costs. Other software and content may be stored on storage 230 for sharing among various computer or other data processing devices. Client 240 may include software application 244 and data 246. Laptop 250 and mobile phone 260 may also include software applications 254 and 264 and data 256 and 266. Facility 280 may include software applications 284 and data 286. Facility 280 may include facility equipment 290 such as inventory management equipment, automated packing equipment, sensory devices for identifying the location of products and when those products are packaged, etc. Facility equipment 290 may include software application 294 and data 296. Other types of data processing systems coupled to network 210 may also include software applications. Software applications could include a web browser, email, or other software application for determining picking costs.

Server 220, storage unit 230, client 240, laptop 250, mobile phone 260, facility 280, and facility equipment 290 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260, facility 280 and facility equipment 290 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

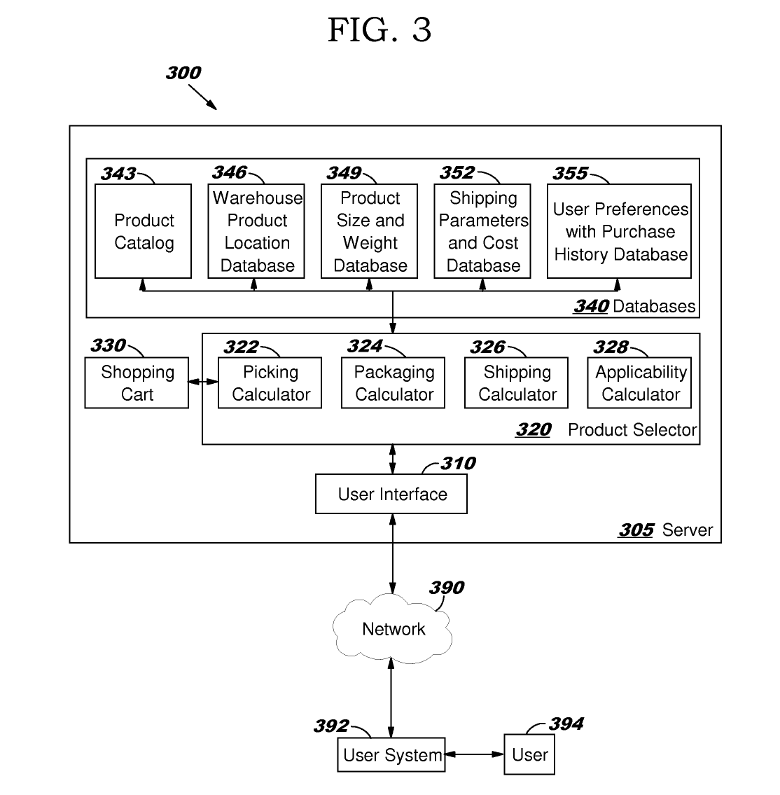

FIG. 3 is a block diagram of a customer ordering system 300 in which various embodiments may be implemented. A server 305 communicates across a network 390 with a user system 392 for allowing a user 394 (also referred to herein as a customer) to order products and to provide upsell opportunities to the user. Server 305 may be a single server, multiple servers or even a cloud implementation. Network 390 may be the internet or other communication network. User system 392 may be a desktop computer, a laptop, a tablet, a smart phone, or other user communication device.

Server 305 includes a user interface 310, a product selector 320, a shopping cart 330, and databases 340. User interface 310 communicates with user system 392 across network 390. User interface 310 also communicates with product selector 320 in providing information about products to the user. Product selector 320 maintains a user shopping cart 330 for each user or customer. Product selector 320 also utilizes databases 340 to offer and sell products through user interface 310, including offering additional products as upsells.

Product selector 320 includes a picking calculator 322, a packaging calculator 324, a shipping calculator 326, and an applicability calculator 328. Picking calculator 322 is able to identify products in close proximity with another product ordered by a user. Products in close proximity may be more easily and cheaply picked when the order is filled for the ordered product. As a result, those products in close proximity may be offered to a user as an upsell as described below. Packaging calculator 324 can determine how to best package an ordered product to lower costs. Packaging calculator 324 can also determine whether additional products may be packaged with the ordered product without increasing costs (e.g., using the same package) or with minimal increases in costs. Shipping calculator 326 can determine the cost of shipping an ordered product while meeting the shipping requirements of the user. Shipping calculator 326 can also determine whether additional products may be shipped with the ordered product without increasing costs or with minimal increases in costs. Applicability calculator 328 can determine whether a product considered for offering to a user as an upsell is applicable to current order. For example, if a user orders a shirt, a tie may be applicable to that order. However, a book on training pets may not be applicable, particularly if a user profile indicates the user is not a pet owner. As described below, statistical information regarding the products and linkages between those products may be utilized to help determine applicability.

Product selector 320 utilizes databases 340 located in server memory for assisting in the user ordering process. These databases store information utilized by the customer ordering system. These databases include a product catalog database 343, warehouse product location database 346, product size and weight database 349, shipping parameters and cost database 352, and user preferences with purchase history database 355. Product catalog database 343 includes products available for purchase by customers. The product catalog can include a detailed description of product including pictures, descriptions, reviews, pricing information, etc. When the user reviews products for possible purchase, this database is utilized to provide information about products to the customer. Statistical information regarding each product may also be stored in the product catalog. For example, linkages to other related products or classes of products may be included with statistical information regarding the strengths of those linkages. These linkages may be preexisting linkages that are manually entered when the catalog is created or updated. These linkages may also be generated based on statistical analysis of orders by customers over time indicating relationships between products. For example, a shirt may be linked to ties generally as a class or to specific ties that match the shirt. Also, statistical analysis may show that purchasers of specific shirts may also be interested in certain sports products and such linkages may be added automatically.

Warehouse product location database 346 identifies where each product is located within a warehouse. This can include the warehouse, the aisle, the rack and the bin where each product is located. One product may be in multiple locations. The number of each product available at each location can also be maintained in this database through tracking orders and shipments in addition to periodic audits of inventory. Product size and weight database 349 can include the dimensions and weight of each product for use in calculating shipping costs. Shipping parameters and cost database 352 includes the cost of shipping goods based in their weight, size, and delivery requirements for one or more shippers. For example, if a user requests overnight delivery then the packaging options (e.g., size of boxes, weights allowed for a given price, etc.) may differ from slower delivery. There may also be different box sizes and prices for different carriers. User preferences with purchase history database 355 include information about various stated user preferences such as whether the user prefers overnight delivery, credit card information, etc. It can also include preference and other attribute information about a user such as income level, whether the user owns pets, is married, etc. that may be obtained from third parties. User preferences with purchase history database 355 also include historical information regarding prior purchases including observed trends and other analytics for use as described below.

Alternative embodiments may utilize alternative database configurations. For example, product selector 320 may include additional calculators or a single calculator for various functions. Product selector 320 may also be combined with user interface 310. Databases 340 may be combined in alternative configurations, such as combining product catalog information with product size and weight data in a single database, or additional or different information may be collected and stored for use.

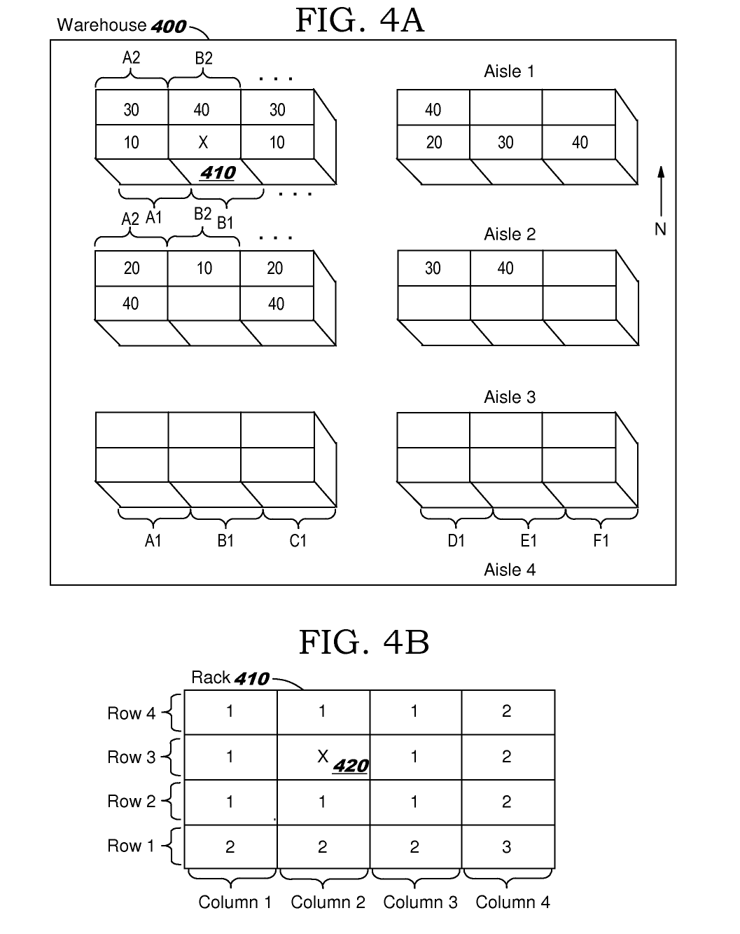

FIGS. 4A and 4B are block diagrams of an example warehouse and a rack utilized for storing products for picking in which various embodiments may be implemented. Many such configurations of warehousing products for sale and shipping may be utilized. Picking costs are a major factor in providing products to a user or users. Picking costs includes the time, manpower, equipment, etc. needed to obtain a product from inventory and provide that product to a staging area for packaging and shipping. Those products that are more easily and cheaply picked when a user order is filled lower costs and overhead. This can include reducing the amount of manpower and equipment needed for picking. These savings can include reducing the number of employees needed during normal working hours as well as during holiday periods that are also known for shopping such as end of year sales.

In FIG. 4A, warehouse 400 includes four aisles labeled Aisle 1, Aisle 2, Aisle 3 and Aisle 4. Each aisle has 6 or 12 racks, each rack including multiple bins. These racks are labeled A1, B1, C1, D1, E1 and F1 on the north side of each aisle and correspondingly A2, B2 (shown), C2, D2, E2 and F2 (not shown) on the south side of each aisle. The outer aisles may have racks on one side only whereas the middle aisles may have racks on both sides of the aisle. Alternative configurations may include a set of racks on the walls for the outer aisles.

In this example, a product located in rack B1 (410) of Aisle 2 has been ordered by a user. This product location rack 410 is marked with an X. Other racks in near proximity to rack 410 are ranked according to their proximity. For example, racks A1, C1 and B2 of Aisle 2 are in close proximity and are ranked as a 10 indicating that close proximity. Other nearby racks such as racks D1, A2 and C2 are also sufficiently close to rack 410 to be ranked as a 20 indicating that nearby proximity. However, those that are ranked as a 20 are not as close as those racks ranked as a 10. Additional racks in proximity to rack 410 may also be ranked as a 30 or a 40 indicating their proximity to rack 410, but also indicating there distance from rack 410 compared to those ranked 10 or 20. This ranking indicates a potential savings in picking costs if the user also orders additional product(s) from these locations, with the greatest savings occurring with products picked from those with the best ranking. That is, a second product ordered from a rack with a 10 ranking has a greater picking savings than a second product ordered from a rack with a 30 ranking. This is due to the close proximity of the second product which requires less time and effort to pick, thereby reducing picking costs. No rankings higher than 40 are shown in this example as any product ordered from bins with a ranking higher than 40 are deemed to not have any picking savings. Of course, additional rankings could be implemented if savings are indicated.

In FIG. 4B, rack 410 is shown with 16 bins. In this example, these 16 bins are in four columns and four rows. The product ordered is located in bin 420 at column 2 and row 3 of rack 410 and is marked with an X. The other bins are ranked according to their proximity to bin 420. That is, those bins closer to bin 420 are given a better ranking such as 1 whereas other bins have a lower ranking of 2 or 3. These rankings indicate the savings which may be experienced if two products in close proximity are ordered by the user. In this example, the rankings are the same relative rankings as described above with reference to FIG. 4A. That is, a bin with a ranking of 3 (column 4, row 1) in FIG. 4B has a much greater savings than the rack with a ranking of 10 shown at Aisle 2, rack A1 or a ranking of 30 shown at Aisle 2, rack E1 of FIG. 4A. Alternative embodiments may utilize different ranking scales for products in the same rack compared to those in different racks.

The example described in FIGS. 4A and 4B can also be updated with a user ordering a second product. That is, if the second product ordered by the user is located in Aisle 2, rack D1, then any additional product in close proximity to one or both of the ordered products (e.g., Aisle 2, rack C1) could provide additional picking savings. As a result, the proximity rankings as described above could be updated reflecting the proximity of products to one or both of the ordered products. In another example, the use may have ordered two or more products not in close proximity to each other, but there may be additional products located in close proximity to the pathway between those products. That is, as the products are picked, there would be cost savings for picking an additional product while on the pathway between the ordered products. As a result, those products in close proximity to the pathway between two or more products are considered to be in close proximity to those products and will receive a better ranking. In addition, a product located close to multiple ordered products may receive an even better ranking than a product located close to a single ordered product. Alternative embodiments may utilize alternative proximity rankings or other measures to reflect the picking cost savings experienced by selling multiple products in close proximity to each other. For example, the actual picking savings could be shown in dollars or other monetary measure for each bin, rack, or other location identifier.

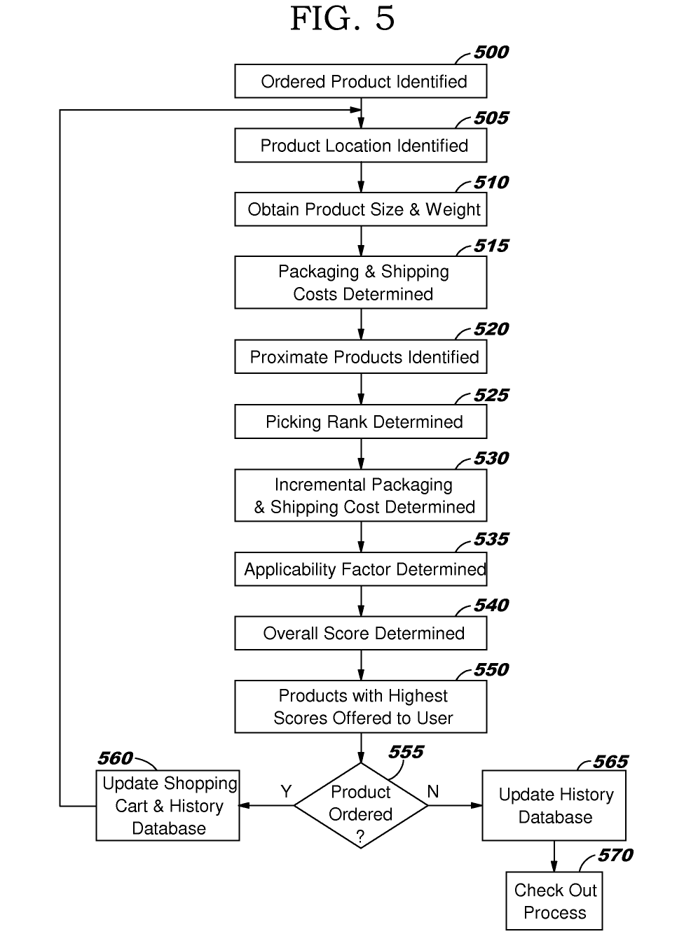

FIG. 5 is a flow diagram of identifying and offering products for upselling in accordance with a first embodiment. In a first step 500, an ordered product(s) is identified by the product selector through the user interface. In a second step 505, a location of the ordered product(s) is identified through use of the warehouse product location database. This can include the warehouse, aisle, rack, bin, etc. In a third step 510, the product size and weight database is utilized to obtain shipping information about the ordered product(s). Then in step 515, packaging and shipping costs for that product(s) are calculated utilizing the shipping parameters and cost database.

Subsequently in step 520, products within proximity of the ordered product(s) (including along the pathway between two ordered products) are identified by reviewing the warehouse product location database. Then in step 525 an incremental picking cost is determined for each proximate product based on its location relative to the ordered product(s). The incremental picking costs may be determined for a subset of the products identified as proximate starting with the products most proximate. That is, if there are a large number of proximate products identified, only those most proximate may be analyzed for incremental picking costs and other costs. The incremental picking cost may be expressed monetarily or as a ranking. Factors for determining incremental picking costs includes a distance of the proximity product to the ordered product(s), a proximity type such as containers versus shelves, and labor costs such as expected worker scheduling and overtime. Incremental packaging and shipping costs are also determined for each proximate product in step 530 by utilizing the product size and weight database and the shipping parameters and cost database. For example, if an ordered product(s) is bulky and lightweight, a small but heavy proximate product may have no incremental packaging or shipping costs. Then in step 535 an applicability factor is determined for each proximate product based on the relatedness of the proximate product to the ordered product(s) from the product catalog database as well as user preferences and user purchasing history which is obtained from the user preferences and purchase history database. This applicability factor can be a relative ranking between proximate products or an absolute ranking based on a derived score where 100 is a perfect score. A variety of techniques could be utilized for determining applicability including preexisting product and product class linkages, statistical analysis of the current or other user activities to determine the likelihood of a user purchasing a product given prior products, user preferences, etc.

In step 540, the incremental picking cost, the incremental packaging cost, the incremental shipping cost and the applicability factor are combined for each proximate product to determine or otherwise rank the proximate products with the highest overall picking scores (which may be expressed monetarily). The relative weighting of each factor can be modified over time based on successful and unsuccessful upsells and user profiles. For example, a picking ranking of 1 to 4 may be normalized (e.g., 50 minus the ranking and then multiplied by 2) and represented by X, the incremental packaging and shipping cost may be normalized (e.g., 1 minus [the incremental cost divided by the largest incremental cost] then multiplied by 100) and represented by Y, and the applicability factor may be normalized (not needed is already ranked from 1 to 100) and represented by Z. In such a case, the weighted average would be Wavg=(W1*X)+(W2*Y)+(W3*Z) where W1+W2+W3=1. For example, if they are equally weighted, then W1, W2 and W3 would each equal to ⅓. For users known for being cost sensitive, lower packaging and shipping cost items may be more heavily weighted (e.g., W2 greater than 0.34). For users with a greater number of multi-product sales over time, items with greater proximity savings and higher applicability may be more heavily weighted (e.g., W1 and W3 greater than 0.34).

Those proximate products with the highest picking scores are then selected and offered to the user as an upsell in step 550. This number can be limited to not overwhelm the user with too many options. The user may also have the capability to limit the number of offered products through user options or through a displayed button provided for the user to view more related products or less related products. In step 555 it is determined whether the user has ordered any additional products (proximate or otherwise). If yes, then in step 560 the shopping cart and the user preferences with purchase history database are updated and processing returns to step 505. In the repeated steps 505 through 555 both ordered products will be processed for determining proximate products relative to both ordered products. If no in step 555, then in step 565 the user preferences with purchase history database to reflect the lack of an upsell and processing continues to process the order through a check out process in step 570 such as known to those of ordinary skill in the art. In an alternative embodiment, discounts on the price of a proximate product may be offered to a user as an enticement to that user.

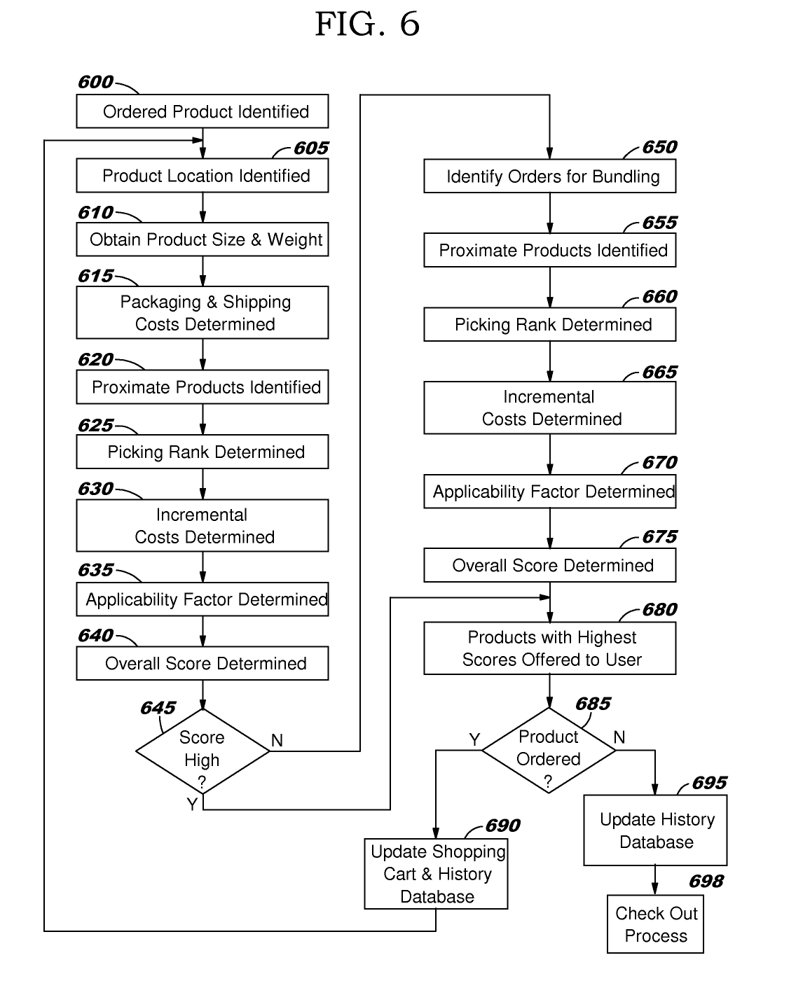

FIG. 6 is a flow diagram of identifying and offering products for upselling in accordance with a second embodiment. In a first step 600, an ordered product(s) is identified by the product selector through the user interface. In a second step 605, a location of the ordered product(s) is identified through use of the warehouse product location database. This can include the warehouse, aisle, rack, bin, etc. In a third step 610, the product size and weight database is utilized to obtain shipping information about the ordered product(s). Then in step 615, packaging and shipping costs for that product(s) are calculated utilizing the shipping parameters and cost database.

Subsequently in step 620, products within proximity of the ordered product(s) (including along the pathway between two ordered products) are identified by reviewing the warehouse product location database. Then in step 625 an incremental picking cost is determined for each proximate product based on its location relative to the ordered product(s). The incremental picking costs may be determined for a subset of the products identified as proximate starting with the products most proximate. That is, if there are a large number of proximate products identified, only those most proximate may be analyzed for incremental picking costs and other costs. The incremental picking cost may be expressed monetarily or as a ranking. Factors for determining incremental picking costs includes a distance of the proximity product to the ordered product(s), a proximity type such as containers versus shelves, and labor costs such as expected worker scheduling and overtime. Incremental packaging and shipping costs are also determined for each proximate product in step 630 by utilizing the product size and weight database and the shipping parameters and cost database. For example, if an ordered product(s) is bulky and lightweight, a small but heavy proximate product may have no incremental packaging or shipping costs. Then in step 635 an applicability factor is determined for each proximate product based on the relatedness of the proximate product to the ordered product(s) from the product catalog database, user preferences, and user purchasing history which is obtained from the user preferences and purchase history database. This applicability factor can be a relative ranking between proximate products or an absolute ranking based on a derived score where 100 is a perfect score. A variety of techniques could be utilized for determining applicability including preexisting product and product class linkages, statistical analysis of the current or other user activities to determine the likelihood of a user purchasing a product given prior products, user preferences, etc.

In step 640, the incremental picking cost, the incremental packaging cost, the incremental shipping cost and the applicability factor are combined for each proximate product to determine or otherwise rank the proximate products with the highest overall picking scores. The relative weighting of each factor can be modified over time based on successful and unsuccessful upsells and user profiles. For example, a picking ranking of 1 to 4 may be normalized (e.g., 50 minus the ranking and then multiplied by 2) and represented by X, the incremental packaging and shipping costs may be normalized (e.g., 1 minus [the incremental cost divided by the largest incremental cost] then multiplied by 100) and represented by Y, and the applicability factor may be normalized (not needed is already ranked from 1 to 100) and represented by Z. In such a case, the weighted average would be Wavg=(W1*X)+(W2*Y)+(W3*Z) where W1+W2+W3=1. For example, if they are equally weighted, then W1, W2 and W3 would each equal to ⅓. For users known for being cost sensitive, lower packaging and shipping cost items may be more heavily weighted (e.g., W2 greater than 0.34). For users with a greater number of multi-product sales over time, items with greater proximity savings and higher applicability may be more heavily weighted (e.g., W1 and W3 greater than 0.34).

It is then determined whether any of the proximate products has a sufficiently high picking score in step 645 (e.g., Wavg less than 60). If not, then the chance for a successful upsell is unlikely, so processing continues to step 650, otherwise processing continues to step 680. In step 650, other orders of others user are reviewed for possible bundling during the picking process. That is, other user's orders may be picked about the same time as the current user order, so incremental picking costs may be reduced by bundling picking orders. Other orders made within a predetermined time period of the current order may be reviewed for bundling. The best orders for bundling with the current order session are those with one or more previously ordered products in close proximity to the currently ordered product(s) by the user. Once one or more user orders have been selected for possible bundling then in step 655 products within proximity of the previously ordered product(s) from other users are identified by reviewing the warehouse product location database. Then in step 660 an incremental picking cost is determined for each proximate product based on its location relative to the previously ordered product(s). The incremental picking cost may be expressed monetarily or as a ranking. Factors for determining incremental picking costs includes a distance of the proximity product to the ordered product(s), a proximity type such as containers versus shelves, and labor costs such as expected worker scheduling and overtime. Incremental packaging and shipping costa are also determined for each proximate product in step 665 by utilizing the product size and weight database and the shipping parameters and cost database. These incremental costs are calculated for proximate products with the ordered product(s), not the previously ordered product(s) from other users. For example, if an ordered product(s) is bulky and lightweight, a small but heavy proximate product may have no incremental packaging or shipping costs. Then in step 670 an applicability factor is determined for each proximate product based on the relatedness of the proximate product to the ordered product(s) from the product catalog database as well as user preferences and user purchasing history which is obtained from the user preferences and purchase history database. This applicability factor can be a relative ranking between proximate products or an absolute ranking based on a derived score where 100 is a perfect score.

In step 675, the incremental picking cost, the incremental packaging cost, the incremental shipping cost and the applicability factor are combined for each proximate product to determine or otherwise rank the proximate products with the highest overall picking scores such as described above with reference to step 640. The relative weighting of each factor can be modified over time based on successful and unsuccessful upsells and user profiles. Processing then continues to step 680.

Those proximate products with the highest picking scores, including those from the current order as determined in step 640 above or the bundled order as determined in step 675, are then selected and offered to the user as an upsell in step 680. This number can be limited to not overwhelm the user with too many options. The user may also have the capability to limit the number of offered products through user options or through a displayed button provided for the user to view more related products or less related products. In step 685 it is determined whether the user has ordered any additional products (proximate or otherwise). If yes, then in step 690 the shopping cart and the user preferences with purchase history database are updated and processing returns to step 605. In addition, the bundling of the orders is retained for use in picking the products. In the repeated steps 605 through 655 both ordered products will be processed for determining proximate products relative to both ordered products. If no in step 680, then in step 695 the user preferences with purchase history database to reflect the lack of an upsell and processing continues to process the order through a check out process in step 698 such as known to those of ordinary skill in the art.

In an alternative embodiment, discounts on the price of a proximate product may be offered to a user as an enticement to that user. In another alternative embodiment, the bundling of multiple orders may occur from the point a user starts an order session. As a result, picking cost saving and applicable offers can be made to a user prior to the user ordering a first product.

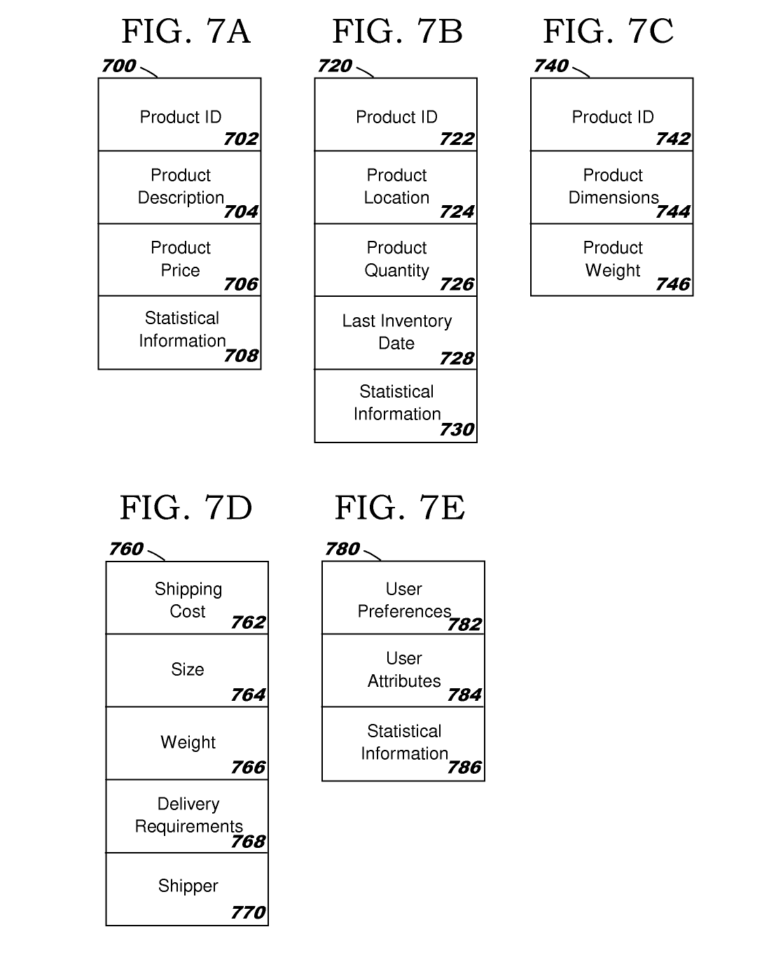

FIGS. 7A-7E are block diagrams of record entries into the various databases in which various embodiments may be implemented. The below described record entries are examples which may be utilized, although alternative examples could easily be utilized by one of ordinary skill in the art.

FIG. 7A is a block diagram of a record entry 700 into the product catalog database. This record entry includes a product ID 702 such as a SKU (stock keeping unit), a product description 704, a product price 706, and statistical information 708. The description can include a picture, reviews, etc. When the user reviews products for possible purchase, these database record entries are utilized to provide information about products to the user. Statistical information regarding each product may also be stored in the product catalog. For example, linkages to other related products or classes of products may be included. These linkages may be preexisting linkages that are manually entered when the catalog is created or updated. These linkages may also be generated based on statistical analysis of orders by customers over time indicating relationships between products. For example, a shirt may be linked to ties generally as a class or to specific ties that match the shirt. Also, statistical analysis may show that purchasers of specific shirts may also be interested in certain sports products and such linkages may be added automatically.

FIG. 7B is a block diagram of a record entry 720 in the warehouse product location database. This record can include the product ID 722 to cross-reference products with the other databases, the product location 724 (e.g., the warehouse, the aisle, the rack and the bin where each product is located), the expected quantity of product available at that location 726, the date that product was last inventoried 728, and statistical information 730 regarding the product at that location. This statistical information can include information useful for managing the inventory such as average sales volume, a confidence interval for the number of product available, etc. The product may be at multiple locations, each product location having a separate record entry, although alternative embodiments may utilize other storage configurations based on the applications.

FIG. 7C is a block diagram of a record entry 740 in the product size and weight database. This record entry includes the product ID 742 to cross-reference products with the other databases, product dimensions 744 and product weight 746 for use in calculating shipping costs. This information may also be stored in the product catalog database.

FIG. 7D is a block diagram of a record entry 760 in the shipping parameters and cost database. This record entry includes the cost of shipping goods 762 based in their size (expressed as a size range) 764, weight (expressed as a weight range) 766, and delivery requirements (e.g., overnight, 2 day, standard) 768 for a shipper 770. As a result, there will be a set of records specifying cost, weight and size for each supplier for each delivery requirement.

FIG. 7E is a block diagram of a record entry 780 in the user preferences with purchase history database. This record entry includes user preferences 782, user attributes 784, and relevant statistical information 786 regarding the user. User preferences 782 can include whether the user prefers overnight delivery, credit card information, etc. User attributes 784 includes information about a user such as income level, whether the user owns pets, is married, etc. that may be obtained from third parties. Relevant statistical information 786 includes historical information regarding prior purchases such as observed purchasing trends as well as analytics for use as described above.

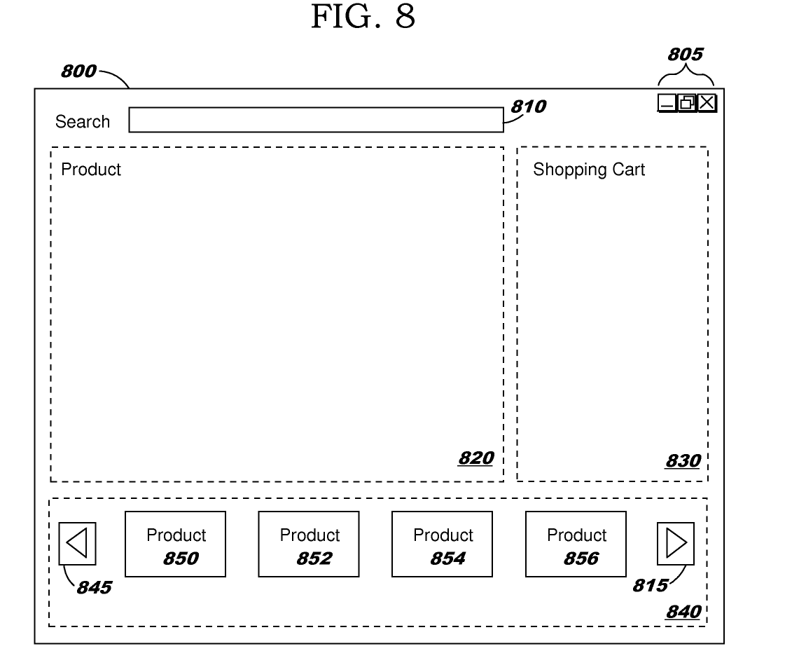

FIG. 8 is a block diagram of a user interface for upselling in which various embodiments may be implemented. The user interface can be implemented as a window 800 includes navigation buttons 805. The window includes a search box 810 for the user to utilize to search for products. For example, the user can type the name of a book and the result can show in product box 820. Product box 820 includes a description of the product including pictures, a written description, reviews, etc. Product box also includes the price of the product and a button for ordering a quantity of the product. Prior orders of products in the current order session (or prior order sessions if the prior orders were not completed) are summarized in shopping cart 830. Shopping cart 830 can include a button for reviewing the shopping cart towards completing the order session including paying for the products ordered.

Box 840 is a list of products offered as upsell opportunities to the user. Box 840 includes navigation buttons 845 and 815 for viewing additional upsell opportunities. These upsell opportunities are identified as described above. In this example, four product boxes 850, 852, 854 and 856 are shown with a brief description which may include a picture and the cost of the product. The user can simply click on one of the upsell opportunity product box and that product will then be displayed in product box 820 with greater detailed information about the product. A different set of upsell opportunity products may then be displayed in box 840. Once an upsell opportunity product is displayed in product box 820, the user can then order that product, click on another upsell opportunity product box, search for another product using search box 810, review the shopping cart, etc. This allows the user to easily navigate a variety of products for possible purchase. The user may also have the capability to limit the number of offered products through user options or through a displayed button provided for the user to view more related products or less related products.

The invention can take the form of an entirely software embodiment, or an embodiment containing both hardware and software elements. In a preferred embodiment, the embodiments are implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for determining picking costs. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for offering a set of candidate products that have a lower picking cost comprising:
detecting a product selected for purchase by a user;
identifying a list of proximate products to the product selected for purchase;
utilizing a processor for ranking the proximate products considering incremental picking costs and applicability of the proximate products to the product selected for purchase to determine picking scores for a subset of the proximate products in the list of proximate products; and
presenting to the user the set of candidate products selected from the subset of proximate products based on the picking scores.

2. The method of claim 1 wherein the incremental picking cost includes a distance of proximate products from the product selected for purchase, a distance of proximate products from a pathway between multiple products selected for purchase, a proximity type, and labor costs.

3. The method of claim 1 further comprising utilizing the processor for determining packaging information for the product selected for purchase; and utilizing the processor for determining incremental packaging costs for proximate products; wherein utilizing the processor for ranking the proximate products includes considering incremental packaging costs.

4. The method of claim 3 further comprising utilizing the processor for determining shipping information for the product selected for purchase; and utilizing the processor for determining incremental shipping costs for proximate products; wherein utilizing the processor for ranking the proximate products includes considering incremental shipping costs.

5. The method of claim 1 wherein identifying the list of proximate products includes identifying products proximate to products ordered by another user.

6. The method of claim 5 wherein the products ordered by another user are bundled for picking with the at least one product selected for purchase by the user.

7. The method of claim 1 wherein utilizing the processor for ranking the proximate products to determine picking scores includes utilizing variable weighting factors of the incremental picking costs and the applicability of the proximate products to the product selected for purchase.

8. The method of claim 1 further comprising utilizing the processor for determining packaging and shipping information for the product selected for purchase; and utilizing the processor for determining incremental packaging and shipping costs for proximate products; wherein utilizing the processor for ranking the proximate products includes considering incremental packaging costs; wherein the incremental picking cost includes a distance of proximate products from the product selected for purchase, a distance of proximate products from a pathway between multiple products selected for purchase, a proximity type, and labor costs; wherein identifying the list of proximate products includes identifying products proximate to products ordered by another user; wherein the products ordered by another user are bundled for picking with the at least one product selected for purchase by the user; and wherein utilizing the processor for ranking the proximate products to determine picking scores includes utilizing variable weighting factors of the incremental picking costs and the applicability of the proximate products to the product selected for purchase.

9. A computer usable program product comprising a non-transitory computer usable storage medium including computer usable code for use in offering a set of candidate products that have a lower picking cost, the computer usable program product comprising code for performing the steps of:
detecting a product selected for purchase by a user;
identifying a list of proximate products to the product selected for purchase;
utilizing a processor for ranking the proximate products considering incremental picking costs and applicability of the proximate products to the product selected for purchase to determine picking scores for a subset of the proximate products in the list of proximate products; and
presenting to the user the set of candidate products selected from the subset of proximate products based on the picking scores.

10. The computer usable program product of claim 9 wherein the incremental picking cost includes a distance of proximate products from the product selected for purchase, a distance of proximate products from a pathway between multiple products selected for purchase, a proximity type, and labor costs.

11. The computer usable program product of claim 9 further comprising utilizing the processor for determining packaging information for the product selected for purchase; and utilizing the processor for determining incremental packaging costs for proximate products; wherein utilizing the processor for ranking the proximate products includes considering incremental packaging costs.

12. The computer usable program product of claim 11 further comprising utilizing the processor for determining shipping information for the product selected for purchase; and utilizing the processor for determining incremental shipping costs for proximate products; wherein utilizing the processor for ranking the proximate products includes considering incremental shipping costs.

13. The computer usable program product of claim 9 wherein identifying the list of proximate products includes identifying products proximate to products ordered by another user.

14. The computer usable program product of claim 13 wherein the products ordered by another user are bundled for picking with the at least one product selected for purchase by the user.

15. The computer usable program product of claim 9 wherein utilizing the processor for ranking the proximate products to determine picking scores includes utilizing variable weighting factors of the incremental picking costs and the applicability of the proximate products to the product selected for purchase.

16. A data processing system for offering a set of candidate products that have a lower picking cost, the data processing system comprising:
a processor; and
a memory storing program instructions which when executed by the processor execute the steps of:
detecting a product selected for purchase by a user;
identifying a list of proximate products to the product selected for purchase;
utilizing a processor for ranking the proximate products considering incremental picking costs and applicability of the proximate products to the product selected for purchase to determine picking scores for a subset of the proximate products in the list of proximate products; and
presenting to the user the set of candidate products selected from the subset of proximate products based on the picking scores.

17. The data processing system of claim 16 wherein the incremental picking cost includes a distance of proximate products from the product selected for purchase, a distance of proximate products from a pathway between multiple products selected for purchase, a proximity type, and labor costs 15 wherein the incremental picking cost includes a distance of proximate products from at least one product selected for purchase, a proximity type, and labor costs.

18. The data processing system of claim 16 wherein identifying the list of proximate products includes identifying products proximate to products ordered by another user.

19. The data processing system of claim 18 wherein the products ordered by another user are bundled for picking with the at least one product selected for purchase by the user.

20. The data processing system of claim 16 wherein utilizing the processor for ranking the proximate products to determine picking scores includes utilizing variable weighting factors of the incremental picking costs and the applicability of the proximate products to the product selected for purchase.
